(19) United States
(12) Patent Application Publication
(10) Pub. No.: US 2024/0355245 A1
(43) Pub. Date: Oct. 24, 2024

(54) DRIVING MULTIPLE ILLUMINATORS USING A SINGLE CONTROLLER RECEIVING MULTIPLE TRIGGER SIGNALS

(71) Applicant: Meta Platforms Technologies, LLC, Menlo Park, CA (US)

(72) Inventors: Liyao Wu, San Jose, CA (US); Wen Cai, Santa Clara, CA (US); Jun Li, San Mateo, CA (US)

(21) Appl. No.: 18/442,442

(22) Filed: Feb. 15, 2024

Related U.S. Application Data
(60) Provisional application No. 63/460,546, filed on Apr. 19, 2023.

(51) Int. Cl. G09G 3/00; G02B 27/00; G02B 27/01

(52) U.S. Cl. CPC G09G 3/002; G02B 27/0093; G02B 27/0172; G09G 3/003; G02B 2027/0178

(57) ABSTRACT

A headset, such as an artificial reality headset, includes one or more illuminators that emit light. A controller, such as an application specific integrated circuit (ASIC) is coupled to a plurality of illuminators. The controller receives multiple trigger signals and generates pulse signals for activating different illuminators in response to each trigger signal. For example, a controller receives at least two trigger signals that can be used to drive different illuminators having different modalities (e.g., eye tracking, depth sensing, etc.). Each trigger signal can occur at a different time than other trigger signals, or may have a different characteristic (e.g., amplitude, pulse width, frequency, etc.) than other trigger signals. Pulse signals generated by the controller for different illuminators based on different trigger signals can also have different characteristics.

### CROSS-REFERENCE TO RELATED APPLICATIONS

This application claims priority to U.S. provisional Application No. 63/460,546 filed Apr. 19, 2023, which is hereby incorporated by reference.

### TECHNICAL FIELD

This disclosure relates generally to artificial reality systems, and more specifically to controlling illumination sources used by artificial reality systems.

### BACKGROUND INFORMATION

Headsets, such as virtual reality (VR) headsets or augmented reality (AR) headsets, often capture information about an environment including the headset that is used when presenting content to a user. For example, a headset includes a depth camera assembly that uses one or more depth sensing methods to identify objects in a local area surrounding the headset and distances between the headset and one or more identified objects. In various implementations, the depth camera assembly emits light from one or more illumination sources, and a sensor captures light from the one or more illumination sources reflected by one or more objects, with data from the sensor used to determine distances between the headset and the one or more objects.

Additionally, a headset may track portions of a user's body while the user wears the headset. For example, the headset tracks movement of the user's eyes, movement of portions of the user's face, movement of the user's hands, or movement of the user's body. To perform such tracking, the headset includes one or more additional illumination sources that differ from one or more illumination sources used to emit light into the local area surrounding the headset for depth sensing. The additional illuminators emit light onto a portion of the user's body, and one or more sensors detect light from the additional illumination sources reflected from one or more portions of the user's body. From the reflected light, the headset locates or tracks portions of the user's body.

However, emitting light into the local area surrounding a headset and emitting light onto portions of a user's body have different conditions, such as timing, illumination pattern, amplitude, frequency, pulse-width, or other characteristics. The differing characteristics account for light being emitted into the local area or onto portions of the user's body. Additionally, synchronizing different illumination sources with corresponding sensors involves flexible control when an illumination source is active, which may involve variable delays between activation of the illumination source. To account for variable timing requirements and light emission characteristics, conventional headsets include a different controller for each illumination source. Such a controller is often an application-specific integrated circuit (ASIC) that receives a trigger input and generates a pulse for emission by an illumination source in response to the trigger input. However, having a different controller for each illumination source increases the amount of space in the headset for operating each illumination source and increases the cost for manufacturing the headset.

### SUMMARY

A headset, such as virtual reality (VR) headset or augmented reality (AR) headset, includes multiple illuminators. Each illuminator is configured to emit light in response to receiving a pulse. For example, an illuminator emits structured light into a local area surrounding the headset, while another illuminator emits structured light onto one or more portions of a user wearing the headset. To simplify operation of multiple illuminators, the headset includes a controller that is coupled to multiple illuminators. The controller is an application-specific integrated circuit (ASIC) configured to receive at least a plurality of trigger signals and to generate at least a plurality of pulse signals. Different pulse signals are generated in response to different trigger signals, and each pulse signal is communicated to a different illuminator. In various embodiments, a first pulse signal is transmitted to a first illuminator, while a second pulse signal is transmitted to a second illuminator. Different pulse signals may have one or more different characteristics (e.g., frequencies, pulse-widths, amplitudes) to account for different modalities in which different illuminators operate. Having a single controller providing pulse signals based on corresponding trigger signals to multiple illuminators allows headsets to use limited space more efficiently and provide increased efficiency for power consumption, while allowing different illuminators to operate in different modalities.

In various embodiments, a system includes a controller comprising an application specific integrated circuit (ASIC). The controller is configured to receive a first trigger signal and a second trigger signal. In response to the first trigger signal, the controller is configured to output a first pulse signal in response to the first trigger signal, while the controller is configured to output a second pulse signal in response to the second trigger signal. A first illuminator is coupled to the controller and configured to receive the first pulse signal from the controller. A second illuminator is coupled to the controller and configured to receive the second pulse signal from the controller.

In various embodiments, an apparatus comprises a first pulse generator configured to receive a first trigger signal and to generate a first pulse signal in response to the first trigger signal. The apparatus also includes a second pulse generator configured to receive a second trigger signal and to generate a second pulse signal in response to the second trigger signal. The second trigger signal is independent of the first trigger signal. In various embodiments, the second trigger signal is independent from the first trigger signal.

In various embodiments, a headset comprises a frame and one or more display elements coupled to the frame, with each display element configured to generate image light for presentation to a user. The frame also includes a first illuminator coupled to the frame and configured to emit light in response to a first pulse signal, as well as a second illuminator coupled to the frame and configured to emit light in response to a second pulse signal. A controller comprising an application-specific integrated circuit (ASIC) is included in the frame and is coupled to the first illuminator and to the second illuminator. The controller is configured to receive a first trigger signal and a second trigger signal, with the second trigger signal independent from the first trigger signal. In response to the first trigger signal, the controller generates the first pulse signal, while the controller generates the second pulse signal in response to the second trigger signal.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1A is a perspective view of a headset implemented as an eyewear device, in accordance with aspects of the disclosure.

FIG. 1B is a perspective view of a headset implemented as a head-mounted display, in accordance with aspects of the disclosure.

FIG. 2 is a block diagram of a controller configured to receive a plurality of trigger signals and to generate a plurality of pluses in response to the trigger signals, in accordance with aspects of the disclosure.

FIG. 3 is an example timing diagram of multiple pulse signals generated by a controller in response to multiple trigger signals, in accordance with aspects of the disclosure.

FIG. 4 in another example timing diagram of multiple pulse signals generated by a controller in response to multiple trigger signals, in accordance with aspects of the disclosure.

FIG. 5 is an additional example timing diagram of multiple pulse signals generated by a controller in response to multiple trigger signals, in accordance with aspects of the disclosure.

FIG. 6 illustrates an example timing diagram of trigger signals having different frequencies, in accordance with aspects of the disclosure.

FIG. 7 is a system that includes a headset, in accordance with aspects of the disclosure.

### DETAILED DESCRIPTION

Embodiments of controllers driving multiple illuminators are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

A headset, such as a virtual reality (VR) headset or an augmented reality (AR) headset, includes multiple illuminators that emit light from the headset. For example, an illuminator emits light into a local area surrounding the headset, while another illuminator emits light onto portions of a user wearing the headset. However, different illuminators emit light having different patterns or emit light having different frequencies, with different pulse-widths, and/or with different amplitudes. To account for different operating characteristics of different emitters, the headset includes a controller that is an application-specific integrated circuit (ASIC) coupled to each of a plurality of illuminators. In other embodiments, the controller is a different type of device, such as a field programmable gate array (FPGA).

The controller receives at least two trigger signals. A trigger signal may be a periodic signal or may be received in response to one or more components of the headset detecting a particular event. Different trigger signals are independent of each other and may be received by the controller at different times or with different frequencies. In response to receiving a trigger signal, the controller generates a pulse signal that is transmitted to an illuminator. The illuminator emits light in response to the pulse signals. Each trigger signal causes the controller to generate a distinct pulse signal. Different pulse signals may have one or more different characteristics, such as amplitude, frequency, or pulse-width, allowing different pulse signals to account for different operating characteristics of different illuminators. Having a single controller providing different pulse signals to different illuminators based on corresponding trigger signals to multiple illuminators allows the headset to use limited space more efficiently and provide increased efficiency for power consumption, while allowing different illuminators to operate in different modalities.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including a wearable device (e.g., headset) connected to a host computer system, a standalone wearable device (e.g., headset), a mobile device or computing system, or any other hardware platform capable of providing artificial reality content to one or more viewers.

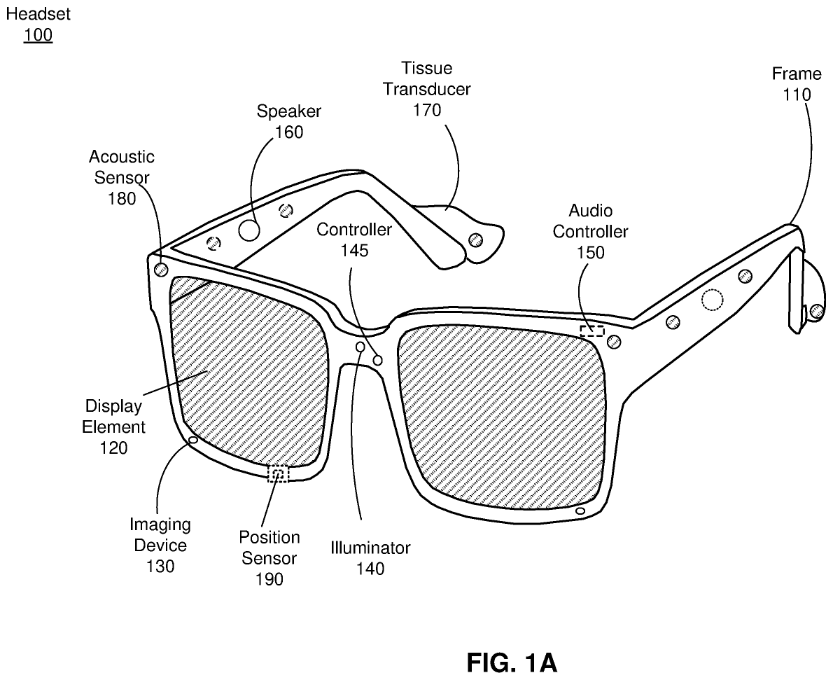

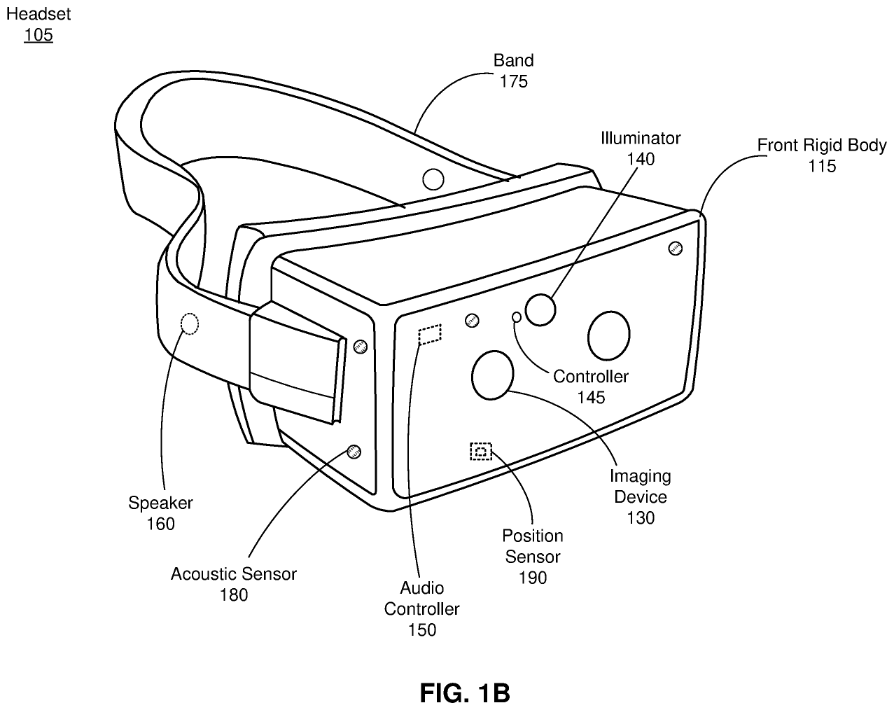

FIG. 1A is a perspective view of a headset 100 implemented as an eyewear device, in accordance with one or more embodiments. In some embodiments, the eyewear device is a near eye display (NED). In general, the headset 100 may be worn on the face of a user such that content (e.g., media content) is presented using a display assembly and/or an audio system. However, the headset 100 may also be used such that media content is presented to a user in a different manner. Examples of media content presented by the headset 100 include one or more images, video, audio, or some combination thereof. The headset 100 includes a frame, and may include, among other components, a display assembly including one or more display elements 120, a depth camera assembly (DCA), an audio system, and a position sensor 190. While FIG. 1A illustrates the components of the headset 100 in example locations on the headset 100, the components may be located elsewhere on the headset 100, on a peripheral device paired with the headset 100, or some combination thereof. Similarly, there may be more or fewer components on the headset 100 than what is shown in FIG. 1A.

The frame 110 holds the other components of the headset 100. The frame 110 includes a front part that holds the one or more display elements 120 and end pieces (e.g., temples) to attach to a head of the user. The front part of the frame 110 bridges the top of a nose of the user. The length of the end pieces may be adjustable (e.g., adjustable temple length) to fit different users. The end pieces may also include a portion that curls behind the ear of the user (e.g., temple tip, earpiece, etc.).

The one or more display elements 120 provide light to a user wearing the headset 100. As illustrated the headset includes a display element 120 for each eye of a user. In some embodiments, a display element 120 generates image light that is provided to an eye-box of the headset 100. The eye-box is a location in space that an eye of user occupies while wearing the headset 100. For example, a display element 120 may be a waveguide display. A waveguide display includes a light source (e.g., a two-dimensional source, one or more line sources, one or more point sources, etc.) and one or more waveguides. Light from the light source is in-coupled into the one or more waveguides which outputs the light in a manner such that there is pupil replication in an eye-box of the headset 100. In-coupling and/or outcoupling of light from the one or more waveguides may be done using one or more diffraction gratings. In some embodiments, the waveguide display includes a scanning element (e.g., waveguide, mirror, etc.) that scans light from the light source as it is in-coupled into the one or more waveguides. Note that in some embodiments, one or both of the display elements 120 are opaque and do not transmit light from a local area around the headset 100. The local area is the area surrounding the headset 100. For example, the local area may be a room that a user wearing the headset 100 is inside, or the user wearing the headset 100 may be outside and the local area is an outside area. In this context, the headset 100 generates VR content. Alternatively, in some embodiments, one or both of the display elements 120 are at least partially transparent, such that light from the local area may be combined with light from the one or more display elements to produce AR and/or MR content.

In some embodiments, a display element 120 does not generate image light, and instead is a lens that transmits light from the local area to the eye-box. For example, one or both of the display elements 120 may be a lens without correction (non-prescription) or a prescription lens (e.g., single vision, bifocal and trifocal, or progressive) to help correct for defects in a user's eyesight. In some embodiments, the display element 120 may be polarized and/or tinted to protect the user's eyes from the sun.

In some embodiments, the display element 120 may include an additional optics block (not shown). The optics block may include one or more optical elements (e.g., lens, Fresnel lens, etc.) that direct light from the display element 120 to the eye-box. The optics block may, e.g., correct for aberrations in some or all of the image content, magnify some or all of the image, or some combination thereof.

The DCA determines depth information for a portion of a local area surrounding the headset 100. The DCA includes one or more imaging devices 130 and a DCA controller (not shown in FIG. 1A), and may also include an illuminator 140. In some embodiments, the illuminator 140 illuminates a portion of the local area with light. The light may be, e.g., structured light (e.g., dot pattern, bars, etc.) in the infrared (IR), IR flash for time-of-flight, etc. In some embodiments, the one or more imaging devices 130 capture images of the portion of the local area that include the light from the illuminator 140. As illustrated, FIG. 1A shows a single illuminator 140 and two imaging devices 130. In alternate embodiments, there is no illuminator 140 and at least two imaging devices 130.

The DCA controller computes depth information for the portion of the local area using the captured images and one or more depth determination techniques. The depth determination technique may be, e.g., direct time-of-flight (ToF) depth sensing, indirect ToF depth sensing, structured light, passive stereo analysis, active stereo analysis (uses texture added to the scene by light from the illuminator 140), some other technique to determine depth of a scene, or some combination thereof.

The DCA may include an eye tracking unit that determines eye tracking information. The eye tracking information may comprise information about a position and an orientation of one or both eyes (within their respective eye-boxes). The eye tracking unit may include one or more cameras. The eye tracking unit estimates an angular orientation of one or both eyes based on images captured of one or both eyes by the one or more cameras. In some embodiments, the eye tracking unit may also include one or more illuminators that illuminate one or both eyes with an illumination pattern (e.g., structured light, glints, etc.). The eye tracking unit may use the illumination pattern in the captured images to determine the eye tracking information. The headset 100 may prompt the user to opt in to allow operation of the eye tracking unit. For example, by opting in the headset 100 may detect, store, images of the user's any or eye tracking information of the user.

In various embodiments, the headset 100 includes multiple illuminators 140 positioned to emit light in different directions. For example, a set of illuminators 140 are positioned to emit light into a local area surrounding the headset, while another set of illuminators 140 are positioned to emit light onto one or more portions of a user's body. Different illuminators 140 may operate in different modalities, with a modality of an illuminator 140 identifying characteristics of light emitted by the illuminator 140. For example, a modality corresponds to depth sensing, where the illuminator 140 emits structured light with one or more specific characteristics into a local area surrounding the headset 100. As another example, a modality corresponds to eye tracking, where an illuminator 140 emits light having one or more particular characteristics onto eyes of a user wearing the headset 100. Other example modalities include face tracking, where light having one or more characteristics is emitted from one or more illuminators 140 onto portions of the user's face, and hand tracking, where light having one or more characteristics is emitted from one or more illuminators 140. Different modalities correspond to different characteristics of light emitted by an illuminator 140, so a modality in which an illuminator 140 operates specifies characteristics of light that the illuminator 140 emits.

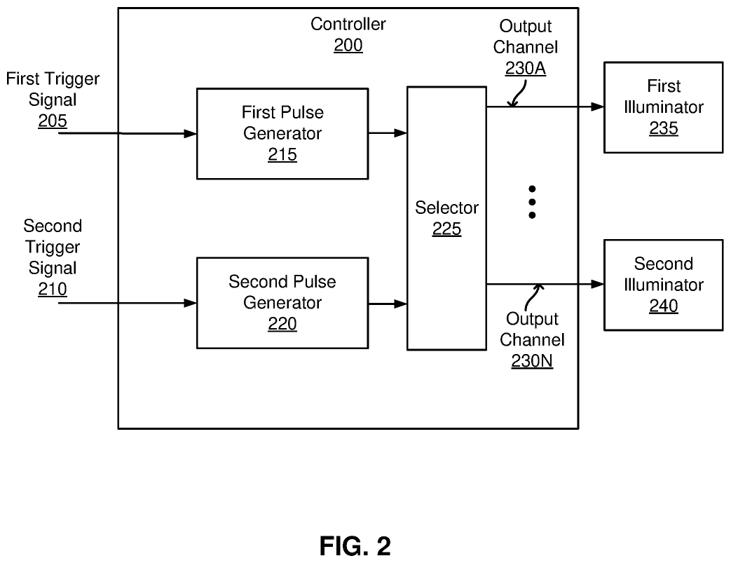

As further described below in conjunction with FIG. 2, multiple illuminators 140 coupled to a controller 145. The controller 145 is an application-specific integrated circuit (ASIC) that receives two or more trigger signals. Each trigger signal is independent of other trigger signals. For example, a trigger signal is received at a different time than the other trigger signals. Different trigger signals have one or more characteristics (e.g., pulse-width, frequency, amplitude, etc.). In response to a trigger signal, the controller 145 generates a pulse signal that is received by an illuminator 140 coupled to the controller 145. The illuminator 140 emits light based on the pulse signal, with a pulse-width, frequency, amplitude, or other characteristic of the pulse signal specifying emission of light by the illuminator 140. To account for different modalities of an illuminator 140, or different illuminators 140, the illuminator 140 generates pulse signals with pulses having different characteristics (e.g., pulse-width, amplitude, frequency, etc.). As further described below in conjunction with FIG. 2, the controller 145 couples different pulse signals to different illuminators 140, so the controller 145 transmits pulse signals to multiple illuminators 140 to regulate emission of light by multiple illuminators 140. Having a single controller 145 receive multiple trigger signals and transmit different pulse signals to different illuminators 140 allows control of multiple illuminators 140 with different modalities, while efficiently using space within the frame 110 for operating various illuminators 140. In some embodiments, the controller 145 is included in a DCA, as further described above.

The audio system provides audio content. The audio system includes a transducer array, a sensor array, and an audio controller 150. However, in other embodiments, the audio system may include different and/or additional components. Similarly, in some cases, functionality described with reference to the components of the audio system can be distributed among the components in a different manner than is described here. For example, some or all of the functions of the controller may be performed by a remote server.

The transducer array presents sound to a user. The transducer array includes a plurality of transducers. A transducer may be a speaker 160 or a tissue transducer 170 (e.g., a bone conduction transducer or a cartilage conduction transducer). Although the speakers 160 are shown exterior to the frame 110, the speakers 160 may be enclosed in the frame 110. In some embodiments, instead of individual speakers for each ear, the headset 100 includes a speaker array comprising multiple speakers integrated into the frame 110 to improve directionality of presented audio content. The tissue transducer 170 couples to the head of the user and directly vibrates tissue (e.g., bone or cartilage) of the user to generate sound. The number and/or locations of transducers may be different from what is shown in FIG. 1A.

The sensor array detects sounds within the local area of the headset 100. The sensor array includes a plurality of acoustic sensors 180. An acoustic sensor 180 captures sounds emitted from one or more sound sources in the local area (e.g., a room). Each acoustic sensor is configured to detect sound and convert the detected sound into an electronic format (analog or digital). The acoustic sensors 180 may be acoustic wave sensors, microphones, sound transducers, or similar sensors that are suitable for detecting sounds.

In some embodiments, one or more acoustic sensors 180 may be placed in an ear canal of each ear (e.g., acting as binaural microphones). In some embodiments, the acoustic sensors 180 may be placed on an exterior surface of the headset 100, placed on an interior surface of the headset 100, separate from the headset 100 (e.g., part of some other device), or some combination thereof. The number and/or locations of acoustic sensors 180 may be different from what is shown in FIG. 1A. For example, the number of acoustic detection locations may be increased to increase the amount of audio information collected and the sensitivity and/or accuracy of the information. The acoustic detection locations may be oriented such that the microphone is able to detect sounds in a wide range of directions surrounding the user wearing the headset 100.

The audio controller 150 processes information from the sensor array that describes sounds detected by the sensor array. The audio controller 150 may comprise a processor and a computer-readable storage medium. The audio controller 150 may be configured to generate direction of arrival (DOA) estimates, generate acoustic transfer functions (e.g., array transfer functions and/or head-related transfer functions), track the location of sound sources, form beams in the direction of sound sources, classify sound sources, generate sound filters for the speakers 160, or some combination thereof.

The position sensor 190 generates one or more measurement signals in response to motion of the headset 100. The position sensor 190 may be located on a portion of the frame 110 of the headset 100. The position sensor 190 may include an inertial measurement unit (IMU). Examples of position sensor 190 include: one or more accelerometers, one or more gyroscopes, one or more magnetometers, another suitable type of sensor that detects motion, a type of sensor used for error correction of the IMU, or some combination thereof. The position sensor 190 may be located external to the IMU, internal to the IMU, or some combination thereof.

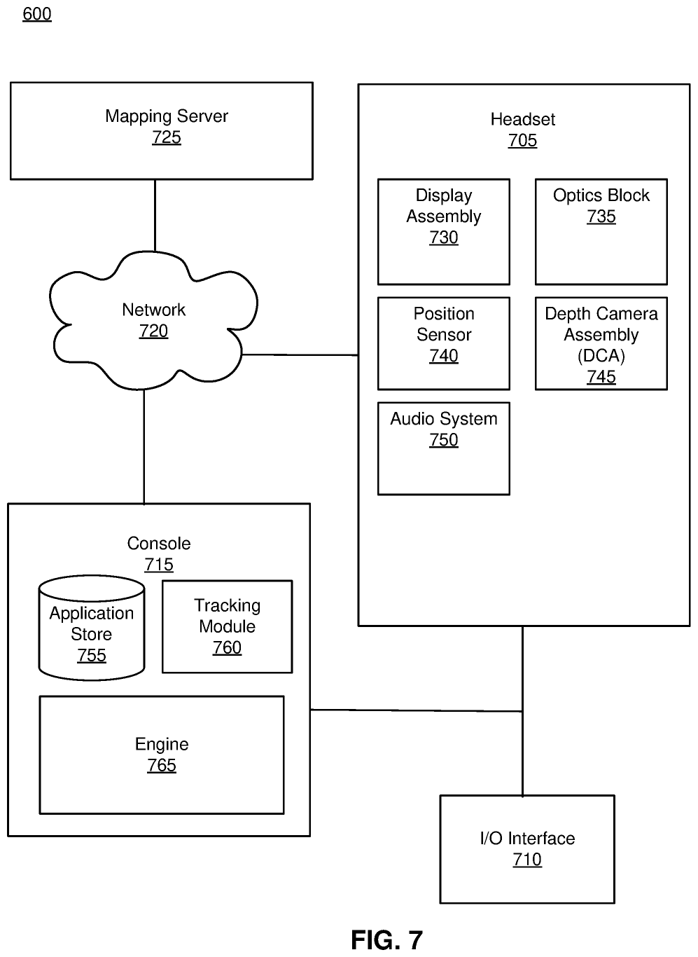

In some embodiments, the headset 100 may provide for simultaneous localization and mapping (SLAM) for a position of the headset 100 and updating of a model of the local area. For example, the headset 100 may include a passive camera assembly (PCA) that generates color image data. The PCA may include one or more RGB cameras that capture images of some or all of the local area. In some embodiments, some or all of the imaging devices 130 of the DCA may also function as the PCA. The images captured by the PCA and the depth information determined by the DCA may be used to determine parameters of the local area, generate a model of the local area, update a model of the local area, or some combination thereof. Furthermore, the position sensor 190 tracks the position (e.g., location and pose) of the headset 100 within the room. Additional details regarding the components of the headset 100 are discussed below in connection with FIG. 7.

FIG. 1B is a perspective view of a headset 105 implemented as an HMD, in accordance with one or more embodiments. In embodiments that describe an AR system and/or a MR system, portions of a front side of the HMD are at least partially transparent in the visible band (˜380 nm to 750 nm), and portions of the HMD that are between the front side of the HMD and an eye of the user are at least partially transparent (e.g., a partially transparent electronic display). The HMD includes a front rigid body 115 and a band 175. The headset 105 includes many of the same components described above with reference to FIG. 1A, but modified to integrate with the HMD form factor. For example, the HMD includes a display assembly, a DCA, an audio system, and a position sensor 190. FIG. 1B shows the illuminator 140, controller 145, a plurality of the speakers 160, a plurality of the imaging devices 130, a plurality of acoustic sensors 180, and the position sensor 190. The speakers 160 may be located in various locations, such as coupled to the band 175 (as shown), coupled to front rigid body 115, or may be configured to be inserted within the ear canal of a user.

FIG. 2 is a block diagram of a controller 200 driving an illumination source, in accordance with one or more embodiments. For example, the controller 200 is the controller 145 further described above in conjunction with FIG. 1A. In various embodiments, different or additional components may be included in the controller 200. Additionally, functionality described in conjunction with one or more of the components shown in FIG. 2 may be distributed among the components in a different manner than described in conjunction with FIG. 2 in some embodiments. In various embodiments, the controller 200 is an application-specific integrated circuit (ASIC) customized to provide the functionality further described below. The controller 200 may be included in a depth camera assembly (DCA) included in a headset 100, in various embodiments.

The controller 200 is configured to receive a first trigger signal 205 and to receive a second trigger signal 210. The first trigger signal 205 is independent from the second trigger signal 210, and the second trigger signal is independent from the first trigger signal 205. In various embodiments, the first trigger signal 205 occurs at a different time than the second trigger signal 210. In various embodiments, one or more characteristics differ between the first trigger signal 205 and the second trigger signal 210. For example, the first trigger signal 205 has a different amplitude than the second trigger signal 210. As another example, the first trigger signal 205 has a different pulse width than the second trigger signal 210. In some embodiments, the first trigger signal 205 has at least one characteristic that differs from the corresponding characteristic of the second trigger signal 210.

The first trigger signal 205 may be received at a first frequency, with the second trigger signal 210 received at a second, different, frequency. In other embodiments, the first trigger signal 205 or the second trigger signal 210 is received in response to an event. For example, one or more sensors are coupled to the controller 200, and a sensor transmits the first trigger signal 205 or the second trigger signal 210 to the controller 200 in response to data captured by the sensor satisfying one or more criteria. In some embodiments, the first trigger signal 205 is received at a fixed frequency, while the second trigger signal 210 is received in response to one or more events, or vice versa. Thus, different trigger signals 205, 210 may be received at different times or at different frequencies.

While FIG. 2 shows the controller 200 receiving a first trigger signal 205 and a second trigger signal 210, in other embodiments, the controller 200 receives more than two trigger signals. For example, the controller 200 receives three trigger signals, four trigger signals, or any number of trigger signals greater than two. Each trigger signal may be received at a different time than each of the other trigger signals or may have at least one characteristic that differs from the corresponding characteristic (e.g., pulse width, amplitude) of each of the other trigger signals. Hence, the controller 200 may receive a different number of trigger signals in different embodiments.

As shown in FIG. 2, the controller 200 includes a first pulse generator 215 configured to receive the first trigger signal 205. Similarly, the controller 200 includes a second pulse generator 220 configured to receive the second trigger signal 210. The first pulse generator 215 generates a first pulse signal comprising a pulse having a first set of characteristics in response to receiving the first trigger signal 205. Similarly, the second pulse generator 220 generates a second pulse signal comprising a pulse having a second set of characteristics in response to receiving the second trigger signal 210. In embodiments where the controller 200 receives more than two trigger signals, each trigger signal is received by a separate pulse generator, allowing generation of a pulse signal corresponding to each distinct trigger signal.

The first pulse generator 215 comprises circuitry that generates a first pulse signal including one or more rectangular pulses (or other pulses) in response to the first trigger signal 205 having a first value or in response to a transition between values of the first trigger signal 205, and does not generate a pulse in response to the first trigger signal 205 having another value. For example, the first pulse generator 215 generates a pulse in response to the first trigger signal 205 having a logical high value or in response to a transition of the first trigger signal 205 from a logical low value to a logical high value. In some embodiments, the first pulse generator 215 receives additional input identifying a pulse width of the generated pulse of the first pulse signal, an amplitude of the generated pulse of the first pulse signal, or other characteristic of pulses of the first pulse signal. Alternatively or additionally, the first pulse generator 215 includes stored data specifying one or more characteristics (e.g., amplitude, pulse width) of pulses of the first pulse signal.

Similarly, the second pulse generator 220 comprises circuitry that generates a second pulse signal comprising one or more rectangular pulses (or other pulses) in response to the second trigger signal 210 having a first value or in response to a transition between values of the second trigger signal, and does not generate a pulse in response to the second trigger signal 210 having another value. For example, the second pulse generator 220 generates a pulse in response to the second trigger signal 210 having a logical high value or having a transition from a logical low value to the logical high value. In some embodiments, the second pulse generator 220 receives additional input identifying a pulse width of the generated pulse of the second pulse signal, an amplitude of the generated pulse of the second pulse signals, or other characteristic of pulses of the second pulse signal. Alternatively or additionally, the second pulse generator 220 includes stored data specifying one or more characteristics (e.g., amplitude, pulse width) of pulses of the second pulse signal.

The first pulse generator 215 and the second pulse generator 220 are each coupled to a selector 225, such as a multiplexer, with the outputs of each of the first pulse generator 215 and the second pulse generator 220 comprising inputs to the selector 225. The selector 225 has multiple output channels 230A-230N. For each of at least a set of the output channels 230A-N, the selector 225 selects an output from the first pulse generator 215 or from the second pulse generator 220 for an output channel 230A-N. Thus, each output channel 230A-N receives a pulse from either the first pulse generator 215 or the second pulse generator 220. Each of the output channels 230A-N may be configured to receive a pulse from either the first pulse generator 215 or from the second pulse generator 220. In various embodiments, the selector 225 includes instructions that identify a pulse generator and a specific output channel 230A-N coupled to an output from the identified pulse generator. For example, the selector 225 couples output channel 230A in FIG. 2 to an output of the first pulse generator 215 based on stored instructions, and similarly couples output channel 230N to an output of the second pulse generator 220 based on the stored instructions. In some embodiments, the selector 225 couples different numbers of output channels 230A-N to outputs of each of the first pulse generator 215 and the second pulse generator 220. For example, different numbers of output channels 230A-N are coupled to the output of the first pulse generator 215 and to the output of the second pulse generator 220. Further, one or more output channels 230A-N are not coupled to an output of at least one pulse generator in some embodiments, allowing one or more of the output channels 230A-N to remain unused. Thus, the selector 225 allows individual output channels 230A-N to be coupled to an output of a specific pulse generator.

The selector 225 allows outputs of different pulse generators to be coupled to different output channels 230A-N. Each output channel 230A-N is coupled to output of a single pulse generator. This allows the controller 200 to direct different pulse signals to different output channels 230A-N, allowing direction of different pulse signals to different components.

In the example of FIG. 2, a first set of output channels 230A-N is coupled to a first illuminator 235, and a second set of output channels 230A-N is coupled to a second illuminator 240. Each output channel 230A-N of the first set is coupled to an output of a common pulse generator, while each output channel 230A-N of the second set is coupled to an output of a different common pulse generator. For example, the first illuminator 235 is coupled to a first set of output channels 230A-N that are coupled to the first pulse generator 215, and the second illuminator 240 is coupled to a second set of output channels 230A-N that are coupled to the second pulse generator 220. In various embodiments, different output channels 230A-N have different limits on characteristics of pulse signals transmitted by the output channels 230A-N. For example, the output channel 230A transmits a pulse signal having a first pulse width or a first amplitude, while the output channel 230N transmits a pulse signal having a second, different, pulse width or a second, different, amplitude. Having different output channels 230A-N transmit pulse signals having different characteristics allows the controller 200 to provide different types of pulse signals as outputs, enabling coupling of components having different input characteristics to the controller 200.

As the selector 225 couples outputs from different pulse width generators to each of the first illuminator 235 and the second illuminator 240, the controller 200 allows operation of different illuminators to operate in different modalities. For example, the first illuminator 235 is part of a DCA of the headset 100 that determines distances between objects in the local area surrounding the headset 100 and the headset 100, with the first illuminator 235 emitting pulses of light in response to receiving pulses from the first pulse generator 215, while the second illuminator 240 is part of an eye tracking system in the headset 100. The second illuminator 240 emits light to illuminate one or more eyes of a user wearing the headset 100 in response to receiving pulses from the second pulse generator 220. In another example, the first illuminator 235 is part of an eye tracking system in the headset 100 that illuminates one or more eyes of the user wearing the headset 100 in response to pulses from the first pulse generator 215, while the second illuminator 240 is part of a face tracking system in the headset 100 that illuminates portions of a face of the user wearing the headset 100 in response to pulses from the second pulse generator 220. This allows the controller 200 to operate different illuminators having different modalities, causing emission of light with different characteristics, such as different wavelengths, different durations for light emission, different amplitudes of emitted light, or other different characteristics of emitted light. Having a single controller 200 provide pulse signals to multiple illuminators allows the single controller 200 to control operation of different illuminators in response to different trigger signals. The pulse signals generated in response to different trigger signals may have different characteristics, allowing the controller 200 to control activation of multiple illuminators specifying operating requirements or characteristics.

In various embodiments, the first illuminator 235 and the second illuminator 240 have different modalities. A modality of an illuminator describes characteristics of light emitted by the illuminator, with different modalities allowing capture of different data (e.g., by a detector being part of the illuminator or coupled to the illuminator). For example, a modality is depth sensing, where an illuminator emits light into a local area for identifying objects in the local area. As another example, a modality is eye tracking, where an illuminator emits light onto a user's eye and captures light reflected by portions of the user's eye. In another example, a modality is face tracking, where an illuminator emits light onto one or more portions of the user's face, and movement or a location of the user's face may be determined from light reflected by portions of the user's face. For an additional example, a modality is hand tracking, where an illuminator emits light onto a user's hand, and a position or movement of the user's hand may be determined from light reflected by the user's hand. A modality in which an illuminator operates specifies characteristics of light emitted by the illuminator, such as a wavelength, a duration of emission, an amplitude, a frequency, a pattern, or other characteristic. So, a modality of an illuminator determines one or more characteristics of light emitted by an illuminator. By outputting multiple pulse signals generated in response to different trigger signals, the controller 200 may generate different pulse signals with different characteristics that correspond to different modalities of an illuminator. This allows the controller 200 to be a single source for activating different illumination that may operate in different modalities, simplifying operation of multiple illuminators in the headset 100.

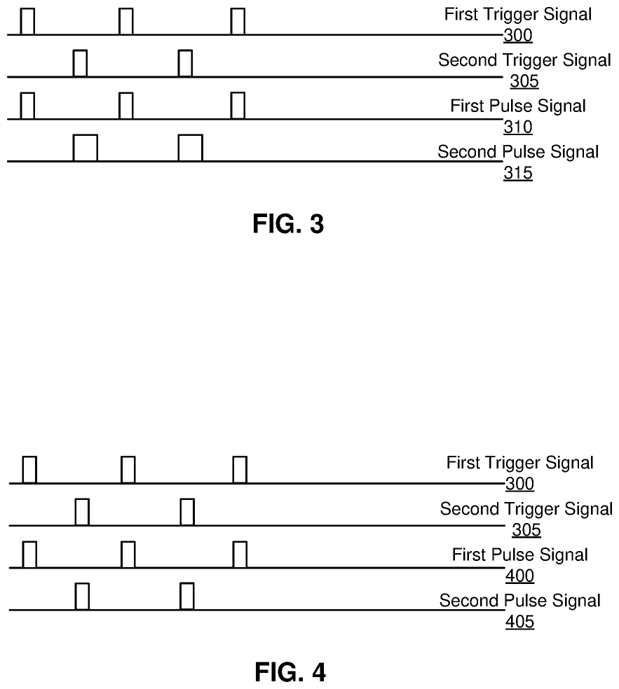

FIG. 3 is an example timing diagram of multiple pulse signals generated by a controller in response to multiple trigger signals, in accordance with one or more embodiments. In various embodiments, the controller is the controller 200 further described above in conjunction with FIG. 2, while in other embodiments, other architectures may be used for the controller.

In the example of FIG. 3, the controller 200 receives a first trigger signal 300 and a second trigger signal 305. As shown in FIG. 3, the first trigger signal 300 and the second trigger signal 305 are received at different times. In some embodiments, the first trigger signal 300 and the second trigger signal 305 are each received at a periodic interval. In some embodiments, the first trigger signal 300 and the second trigger signal 305 have different periodic intervals. Alternatively, the first trigger signal 300 or the second trigger signal 305 is received in response to detection of a specific event, rather than at a periodic interval.

In response to the first trigger signal 300 having a first value (e.g., a logical high value) or a transition between values of the first trigger signal 300, the controller 200 generates a pulse for a first pulse signal 310. As further described above in conjunction with FIG. 2, the controller 200 includes the first pulse generator 215 that receives the first trigger signal 300 and generates the first pulse signal 310. Similarly, in response to the second trigger signal 305 having a first value (e.g., a logical high value) or a transition between values of the second trigger signal 305, the controller 200 generates a pulse of a second pulse signal 315. As further described above in conjunction with FIG. 2, the controller 200 includes the second pulse generator 220 that receives the second trigger signal 305 and generates the second pulse signal 315.

In the example shown by FIG. 3, the first pulse signal 310 and the second pulse signal 315 have at least one different characteristic. In the example of FIG. 3, pulses of the first pulse signal 310 have smaller pulse-widths than pulses of the second pulse signal 315. As another example, pulses of the first pulse signal 310 have a different amplitude than pulses of the second pulse signal 315. Thus, the controller 200 generates different pulse signals each having pulses with a different characteristic in response to each of a plurality of trigger signals in the example of FIG. 3. This allows the controller 200 to account for different characteristics or requirements of a component (e.g., the first illuminator 235) receiving the first pulse signal 310, and another component (e.g., the second illuminator 240) receiving the second pulse signal 315.

FIG. 4 shows another example timing diagram of multiple pulse signals generated by a controller 200 in response to multiple trigger signals, in accordance with one or more embodiments. In the example of FIG. 4, the controller 200 receives the first trigger signal 300 and the second trigger signal 305, as further described above in conjunction with FIG. 3. In response to the first trigger signal 300 having a first value or a change in value of the first trigger signal 300, the controller 200 generates a first pulse signal 400. Similarly, in response to the second trigger signal 305 having a first value or a change in value of the first trigger signal 305, the controller 200 generates a second pulse signal 405. In the example of FIG. 4, the first pulse signal 400 and the second pulse signal 405 have common characteristics, such as pulse-width and amplitude, but are generated at different times based on differences in times when the controller 200 receives the first trigger signal 300 and the second trigger signal 305. Such an embodiment allows the controller 200 to generate different pulse signals at different frequencies or at different times, based on different trigger signals, while the pulses generated for each pulse signal have common characteristics.

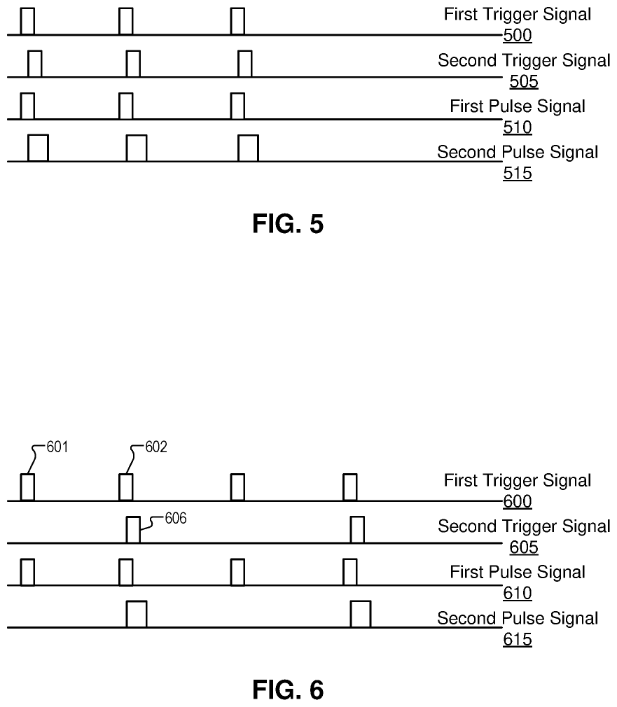

FIG. 5 is an additional example timing diagram of multiple pulse signals generated by a controller in response to multiple trigger signals, in accordance with one or more embodiments. In the example of FIG. 5 the controller 200 receives a first trigger signal 500 and a second trigger signal 505. In response to the first trigger signal 500 having a first value or a change in value of the first trigger signal 500, the controller 200 generates a first pulse signal 510. Similarly, in response to the second trigger signal 505 having a first value or a change in value of the second trigger signal 505, the controller 200 generates a second pulse signal 515. In the example of FIG. 5, the first pulse signal 510 and the second pulse signal 515 are generated at partially overlapping times because of the relative timing of the first trigger signal 500 and the second trigger signal 505. The temporal overlap between portions of pulses of the first pulse signal 510 and pulses of the second pulse signal 515 differs from the examples described above in conjunction with FIGS. 3 and 4, where pulses generated for different pulse signals did not temporally overlap. Hence, in some embodiments, the controller 200 generates both the first pulse signal 510 and the second pulse signal 515 so times when pulses of the first pulse signal 510 and pulses of the second pulse signal 515 are generated at least partially overlap. An amount of overlap between pulses of the first pulse signal 510 and pulses of the second pulse signal 515 may be based on available power for one or more components (e.g., illuminators) that are controlled by the first pulse signal 510 or by the second pulse signal 515 or based on other characteristics of the one or more components controlled by the first pulse signal 510 or by the second pulse signal 515.

FIG. 6 is an additional example timing diagram of multiple pulse signals generated by a controller in response to multiple trigger signals, in accordance with one or more embodiments. In the example of FIG. 6 the controller 200 receives a first trigger signal 600 and a second trigger signal 605. In response to the first trigger signal 600 having a first value or a change in value of the first trigger signal 600, the controller 200 generates a first pulse signal 610. Similarly, in response to the second trigger signal 605 having a first value or a change in value of the second trigger signal 605, the controller 200 generates a second pulse signal 615. FIG. 6 shows that first trigger signal 600 may have a different frequency than second trigger signal 605. In the particular illustration of FIG. 6, the first trigger signal 600 has is activated twice (pulses 601 and 602) before the second trigger signal 605 is activated for the first time (pulse 606).

FIG. 7 is a system 700 that includes a headset 705, in accordance with one or more embodiments. In some embodiments, the headset 705 may be the headset 100 of FIG. 1A or the headset 105 of FIG. 1B. The system 700 may operate in an artificial reality environment (e.g., a virtual reality environment, an augmented reality environment, a mixed reality environment, or some combination thereof). The system 700 shown by FIG. 7 includes the headset 705, an input/output (I/O) interface 710 that is coupled to a console 715, the network 720, and the mapping server 725. While FIG. 7 shows an example system 700 including one headset 705 and one I/O interface 710, in other embodiments any number of these components may be included in the system 700. For example, there may be multiple headsets each having an associated I/O interface 710, with each headset and I/O interface 710 communicating with the console 715. In alternative configurations, different and/or additional components may be included in the system 700. Additionally, functionality described in conjunction with one or more of the components shown in FIG. 7 may be distributed among the components in a different manner than described in conjunction with FIG. 7 in some embodiments. For example, some or all of the functionality of the console 715 may be provided by the headset 705.

The headset 705 includes the display assembly 730, an optics block 735, one or more position sensors 740, and a DCA 745. Some embodiments of headset 705 have different components than those described in conjunction with FIG. 7. Additionally, the functionality provided by various components described in conjunction with FIG. 7 may be differently distributed among the components of the headset 705 in other embodiments, or be captured in separate assemblies remote from the headset 705.

The display assembly 730 displays content to the user in accordance with data received from the console 715. The display assembly 730 displays the content using one or more display elements (e.g., the display elements 120). A display element may be, e.g., an electronic display. In various embodiments, the display assembly 730 comprises a single display element or multiple display elements (e.g., a display for each eye of a user). Examples of an electronic display include: a liquid crystal display (LCD), an organic light emitting diode (OLED) display, an active-matrix organic light-emitting diode display (AMOLED), a waveguide display, some other display, or some combination thereof. Note in some embodiments, the display element 120 may also include some or all of the functionality of the optics block 735.

The optics block 735 may magnify image light received from the electronic display, corrects optical errors associated with the image light, and presents the corrected image light to one or both eye-boxes of the headset 705. In various embodiments, the optics block 735 includes one or more optical elements. Example optical elements included in the optics block 735 include: an aperture, a Fresnel lens, a convex lens, a concave lens, a filter, a reflecting surface, or any other suitable optical element that affects image light. Moreover, the optics block 735 may include combinations of different optical elements. In some embodiments, one or more of the optical elements in the optics block 735 may have one or more coatings, such as partially reflective or anti-reflective coatings.

Magnification and focusing of the image light by the optics block 735 allows the electronic display to be physically smaller, weigh less, and consume less power than larger displays. Additionally, magnification may increase the field of view of the content presented by the electronic display. For example, the field of view of the displayed content is such that the displayed content is presented using almost all (e.g., approximately 110 degrees diagonal), and in some cases, all of the user's field of view. Additionally, in some embodiments, the amount of magnification may be adjusted by adding or removing optical elements.

In some embodiments, the optics block 735 may be designed to correct one or more types of optical error. Examples of optical error include barrel or pincushion distortion, longitudinal chromatic aberrations, or transverse chromatic aberrations. Other types of optical errors may further include spherical aberrations, chromatic aberrations, or errors due to the lens field curvature, astigmatisms, or any other type of optical error. In some embodiments, content provided to the electronic display for display is pre-distorted, and the optics block 735 corrects the distortion when it receives image light from the electronic display generated based on the content.

The position sensor 740 is an electronic device that generates data indicating a position of the headset 705. The position sensor 740 generates one or more measurement signals in response to motion of the headset 705. The position sensor 190 is an embodiment of the position sensor 740. Examples of a position sensor 740 include: one or more IMUs, one or more accelerometers, one or more gyroscopes, one or more magnetometers, another suitable type of sensor that detects motion, or some combination thereof. The position sensor 740 may include multiple accelerometers to measure translational motion (forward/back, up/down, left/right) and multiple gyroscopes to measure rotational motion (e.g., pitch, yaw, roll). In some embodiments, an IMU rapidly samples the measurement signals and calculates the estimated position of the headset 705 from the sampled data. For example, the IMU integrates the measurement signals received from the accelerometers over time to estimate a velocity vector and integrates the velocity vector over time to determine an estimated position of a reference point on the headset 705. The reference point is a point that may be used to describe the position of the headset 705. While the reference point may generally be defined as a point in space, however, in practice the reference point is defined as a point within the headset 705.

The DCA 745 generates depth information for a portion of the local area. The DCA includes one or more imaging devices and a DCA controller. The DCA 745 may also include an illuminator. Operation and structure of the DCA 745 is described above with regard to FIG. 1A.

In various embodiments, the DCA 745 includes a controller, or is coupled to a controller, as further described above in conjunction with FIGS. 2-6. The controller receives multiple trigger signals and generates a pulse signal in response to each trigger signal, in some implementations. In other implementations, the controller is configured to receive one trigger signal. Multiple illuminators are coupled to the controller, so each illuminator receives a pulse signal generated in response to a different trigger signal. This allows a single controller to provide different pulse signals to activate different illuminators. As the controller generates pulse signals in response to trigger signals, differences in times between trigger signals cause differences in times between different illuminators receiving pulse signals for activation. As further described above in conjunction with FIGS. 2-5, different pulse signals may have different characteristics, allowing the controller to account for different modalities in which different illuminators operate.

The audio system 750 provides audio content to a user of the headset 705. The audio system 750 is substantially the same as the audio system 200 described above. The audio system 750 may comprise one or acoustic sensors, one or more transducers, and an audio controller. The audio system 750 may provide spatialized audio content to the user. In some embodiments, the audio system 750 may request acoustic parameters from the mapping server 725 over the network 720. The acoustic parameters describe one or more acoustic properties (e.g., room impulse response, a reverberation time, a reverberation level, etc.) of the local area. The audio system 750 may provide information describing at least a portion of the local area from e.g., the DCA 745 and/or location information for the headset 705 from the position sensor 740. The audio system 750 may generate one or more sound filters using one or more of the acoustic parameters received from the mapping server 725, and use the sound filters to provide audio content to the user.

The I/O interface 710 is a device that allows a user to send action requests and receive responses from the console 715. An action request is a request to perform a particular action. For example, an action request may be an instruction to start or end capture of image or video data, or an instruction to perform a particular action within an application. The I/O interface 710 may include one or more input devices. Example input devices include: a keyboard, a mouse, a game controller, or any other suitable device for receiving action requests and communicating the action requests to the console 715. An action request received by the I/O interface 710 is communicated to the console 715, which performs an action corresponding to the action request. In some embodiments, the I/O interface 710 includes an IMU that captures calibration data indicating an estimated position of the I/O interface 710 relative to an initial position of the I/O interface 710. In some embodiments, the I/O interface 710 may provide haptic feedback to the user in accordance with instructions received from the console 715. For example, haptic feedback is provided when an action request is received, or the console 715 communicates instructions to the I/O interface 710 causing the I/O interface 710 to generate haptic feedback when the console 715 performs an action.

The console 715 provides content to the headset 705 for processing in accordance with information received from one or more of: the DCA 745, the headset 705, and the I/O interface 710. In the example shown in FIG. 7, the console 715 includes an application store 755, a tracking module 760, and an engine 765. Some embodiments of the console 715 have different modules or components than those described in conjunction with FIG. 7. Similarly, the functions further described below may be distributed among components of the console 715 in a different manner than described in conjunction with FIG. 7. In some embodiments, the functionality discussed herein with respect to the console 715 may be implemented in the headset 705, or a remote system.

The application store 755 stores one or more applications for execution by the console 715. An application is a group of instructions, that when executed by a processor, generates content for presentation to the user. Content generated by an application may be in response to inputs received from the user via movement of the headset 705 or the I/O interface 710. Examples of applications include: gaming applications, conferencing applications, video playback applications, or other suitable applications.

The tracking module 760 tracks movements of the headset 705 or of the I/O interface 710 using information from the DCA 745, the one or more position sensors 740, or some combination thereof. For example, the tracking module 760 determines a position of a reference point of the headset 705 in a mapping of a local area based on information from the headset 705. The tracking module 760 may also determine positions of an object or virtual object. Additionally, in some embodiments, the tracking module 760 may use portions of data indicating a position of the headset 705 from the position sensor 740 as well as representations of the local area from the DCA 745 to predict a future location of the headset 705. The tracking module 760 provides the estimated or predicted future position of the headset 705 or the I/O interface 710 to the engine 765.

The engine 765 executes applications and receives position information, acceleration information, velocity information, predicted future positions, or some combination thereof, of the headset 705 from the tracking module 760. Based on the received information, the engine 765 determines content to provide to the headset 705 for presentation to the user. For example, if the received information indicates that the user has looked to the left, the engine 765 generates content for the headset 705 that mirrors the user's movement in a virtual local area or in a local area augmenting the local area with additional content. Additionally, the engine 765 performs an action within an application executing on the console 715 in response to an action request received from the I/O interface 710 and provides feedback to the user that the action was performed. The provided feedback may be visual or audible feedback via the headset 705 or haptic feedback via the I/O interface 710.

The network 720 couples the headset 705 and/or the console 715 to the mapping server 725. The network 720 may include any combination of local area and/or wide area networks using both wireless and/or wired communication systems. For example, the network 720 may include the Internet, as well as mobile telephone networks. In one embodiment, the network 720 uses standard communications technologies and/or protocols. Hence, the network 720 may include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 720 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 720 can be represented using technologies and/or formats including image data in binary form (e.g., Portable Network Graphics (PNG), hypertext markup language (HTML), extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc.

The mapping server 725 may include a database that stores a virtual model describing a plurality of spaces, wherein one location in the virtual model corresponds to a current configuration of a local area of the headset 705. The mapping server 725 receives, from the headset 705 via the network 720, information describing at least a portion of the local area and/or location information for the local area. The user may adjust privacy settings to allow or prevent the headset 705 from transmitting information to the mapping server 725. The mapping server 725 determines, based on the received information and/or location information, a location in the virtual model that is associated with the local area of the headset 705. The mapping server 725 determines (e.g., retrieves) one or more acoustic parameters associated with the local area, based in part on the determined location in the virtual model and any acoustic parameters associated with the determined location. The mapping server 725 may transmit the location of the local area and any values of acoustic parameters associated with the local area to the headset 705.

One or more components of system 700 may contain a privacy module that stores one or more privacy settings for user data elements. The user data elements describe the user or the headset 705. For example, the user data elements may describe a physical characteristic of the user, an action performed by the user, a location of the user of the headset 705, a location of the headset 705, a head-related transfer function (HRTF) for the user, etc. Privacy settings (or “access settings”) for a user data element may be stored in any suitable manner, such as, for example, in association with the user data element, in an index on an authorization server, in another suitable manner, or any suitable combination thereof.

A privacy setting for a user data element specifies how the user data element (or particular information associated with the user data element) can be accessed, stored, or otherwise used (e.g., viewed, shared, modified, copied, executed, surfaced, or identified). In some embodiments, the privacy settings for a user data element may specify a “blocked list” of entities that may not access certain information associated with the user data element. The privacy settings associated with the user data element may specify any suitable granularity of permitted access or denial of access. For example, some entities may have permission to see that a specific user data element exists, some entities may have permission to view the content of the specific user data element, and some entities may have permission to modify the specific user data element. The privacy settings may allow the user to allow other entities to access or store user data elements for a finite period of time.

The privacy settings may allow a user to specify one or more geographic locations from which user data elements can be accessed. Access or denial of access to the user data elements may depend on the geographic location of an entity who is attempting to access the user data elements. For example, the user may allow access to a user data element and specify that the user data element is accessible to an entity only while the user is in a particular location. If the user leaves the particular location, the user data element may no longer be accessible to the entity. As another example, the user may specify that a user data element is accessible only to entities within a threshold distance from the user, such as another user of a headset within the same local area as the user. If the user subsequently changes location, the entity with access to the user data element may lose access, while a new group of entities may gain access as they come within the threshold distance of the user.

The system 700 may include one or more authorization/privacy servers for enforcing privacy settings. A request from an entity for a particular user data element may identify the entity associated with the request and the user data element may be sent only to the entity if the authorization server determines that the entity is authorized to access the user data element based on the privacy settings associated with the user data element. If the requesting entity is not authorized to access the user data element, the authorization server may prevent the requested user data element from being retrieved or may prevent the requested user data element from being sent to the entity. Although this disclosure describes enforcing privacy settings in a particular manner, this disclosure contemplates enforcing privacy settings in any suitable manner.

### Additional Configuration Information

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A system comprising:
a controller comprising an application specific integrated circuit, the controller configured to receive a first trigger signal and a second trigger signal, the controller configured to output a first pulse signal in response to the first trigger signal and to output a second pulse signal in response to the second trigger signal;
a first illuminator coupled to the controller, the first illuminator configured to receive the first pulse signal from the controller; and
a second illuminator coupled to the controller, the second illuminator configured to receive the second pulse signal from the controller.

2. The system of claim 1, wherein the first illuminator operates in a first modality and the second illuminator operates in a second modality different than the first modality.

3. The system of claim 2, wherein the first modality and the second modality are selected from a group consisting of: depth sensing, eye tracking, face tracking, hand tracking, and any combination thereof.

4. The system of claim 1, wherein the first trigger signal is received at a different time than the second trigger signal.

5. The system of claim 1, wherein the first trigger signal is received at a different frequency than the second trigger signal.

6. The system of claim 1, wherein the first pulse signal has at least one characteristic differing from a corresponding characteristic of the second pulse signal.

7. The system of claim 6, wherein the at least one characteristic is selected from a group consisting of: a pulse width, an amplitude, and any combination thereof.

8. The system of claim 1, wherein the controller further comprises:
a first pulse generator configured to receive the first trigger signal and to generate the first pulse signal based on the first trigger signal;
a second pulse generator configured to receive the second trigger signal and to generate the second pulse signal based on the second trigger signal; and
a selector coupled to the first pulse generator, to the second pulse generator, and to a plurality of output channels, the selector configured to couple an output channel of the plurality of output channels to either the first pulse generator or to the second pulse generator.

9. The system of claim 8, wherein a set of the plurality of output channels are each coupled to the first pulse generator and an additional set of the plurality of output channels are each coupled to the second pulse generator, the additional set not including an output channel from the set.

10. An apparatus comprising:
a first pulse generator configured to receive a first trigger signal and to generate a first pulse signal in response to the first trigger signal; and
a second pulse generator configured to receive a second trigger signal and to generate a second pulse signal in response to the second trigger signal, where the second trigger signal is independent from the first trigger signal.

11. The apparatus of claim 10, wherein the first trigger signal is received at a different time than the second trigger signal.

12. The apparatus of claim 10, wherein the first trigger signal is received at a different frequency than the second trigger signal.

13. The apparatus of claim 10, wherein the first pulse signal has at least one characteristic different from a corresponding characteristic of the second pulse signal.

14. The apparatus of claim 13, wherein the at least one characteristic is a pulse width, an amplitude, or a pulse count.

15. The apparatus of claim 10, further comprising:
a selector coupled to the first pulse generator, to the second pulse generator, and to each of a plurality of output channels, the selector configured to couple an output channel of the plurality of output channels to either the first pulse generator or to the second pulse generator.

16. The apparatus of claim 15, wherein a set of the plurality of output channels are each coupled to the first pulse generator and an additional set of the plurality of output channels are each coupled to the second pulse generator, the additional set not including an output channel from the set.

17. A headset comprising:
a frame;
one or more display elements coupled to the frame, each display element configured to generate image light for presentation to a user;
a first illuminator coupled to the frame and configured to emit light in response to a first pulse signal;
a second illuminator coupled to the frame and configured to emit light in response to a second pulse signal; and
a controller comprising an application specific integrated circuit coupled to the first illuminator and to the second illuminator, the controller configured to:
receive a first trigger signal and a second trigger signal, the second trigger signal independent from the first trigger signal;
generate the first pulse signal in response to the first trigger signal; and
generate the second pulse signal in response to the second trigger signal.

18. The headset of claim 17, wherein the first illuminator operates in a first modality and the second illuminator operates in a second modality different than the first modality.

19. The headset of claim 18, wherein the first modality is selected from a group consisting of: depth sensing, eye tracking, face tracking, hand tracking, and any combination thereof.

20. The headset of claim 17, wherein the first pulse signal has at least one characteristic differing from a corresponding characteristic of the second pulse signal.
